(19) United States
(12) Patent Application Publication
(10) Pub. No.: US 2004/0047338 A1
(43) Pub. Date: Mar. 11, 2004

(54) Apparatus and method for data interchange

(75) Inventors: Bernd Gronostay, Waltrop (DE); Gregor Scholl, Witten (DE); Otto Schroeter, Essen (DE)

Correspondence Address: STAAS & HALSEY LLP, SUITE 700, 1201 NEW YORK AVENUE, N.W., WASHINGTON, DC, 20005, US

(73) Assignee: Siemens Aktiengesellschaft

(21) Appl. No.: 10/237,187

(22) Filed: Sep. 9, 2002

(30) Foreign Application Priority Data
Sep. 7, 2002 (DE) 101 43 937.7

(51) Int. Cl. H04L 12/66

(52) U.S. Cl. 370/352; 370/522

(57) ABSTRACT

Data are interchanged between a communications application and a communications installation via an IP network. To this end, the communications application uses an application-end primary control unit to communicate with the communications installation. A first transmission path is used to interchange basic control data and the user data on the basis of a first transmission standard between the primary control unit and the communications installation, and a second transmission path based on a second transmission standard is used to interchange extended control data between an auxiliary control unit and the communications installation. For transmission in the direction from the communications installation to the communications application, the basic control data are first transferred from the primary control unit to the auxiliary control unit, are combined with the extended control data by the auxiliary control unit, and are then transmitted as combined control data from the auxiliary control unit to the primary control unit for forwarding to the communications application, and vice versa.

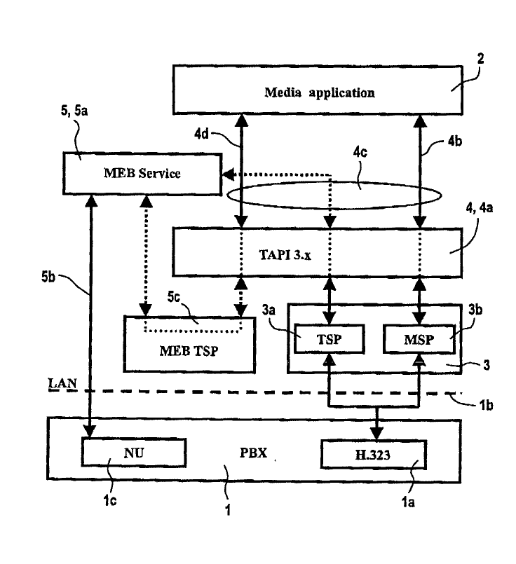

### CROSS REFERENCE TO RELATED APPLICATIONS

This application is based on and hereby claims priority to German Application No. 101 43 937.7 filed on Sep. 7, 2001, the contents of which are hereby incorporated by reference.

### BACKGROUND OF THE INVENTION

Terminal systems operating on the basis of the Voice-over-Internet Protocol (VoIP; IP=Internet Protocol) are known generally. In this context, two communications appliances, for example a telecommunications installation and a multimedia computer (PC), are connected to one another via a data network. With this protocol, user data, that is to say voice and video information, for example, and control data are transmitted via the data network in the form of data packets. Transmission is effected in a constant fashion on the basis of a known standard, e.g. on the basis of the H.323 standard. The H.323 standard defines the transmission of the control data and the parallel transmission of various types of user data, for example satisfying various video and audio standards.

Communications terminals in the form of PCs use application programs, generally referred to as media applications, as a user interface. Such a media application transmits and receives the user data and control data via a standardized programming interface, particularly the Telephony Application Programming Interface (TAPI). This programming interface is made available by a “primary control unit”, which is often also referred to as a TAPI driver. The primary control unit installed on the PC interchanges the user data and control data firstly with the communications installation via the data network, using the H.323 standard, and secondly with the media application via the TAPI interface. Both between the media application and the primary control unit and between the primary control unit and the telecommunications installation, there are two respective logical data links active for a communications link, namely a user data channel and a control data channel. These two data channels are combined in the data network to form a common channel (H.323 channel), and are consequently transmitted from and to the telecommunications installation via this common H.323 channel.

In addition, CTI communications applications (Computer Telephony Integration) are known which use the TAPI driver to control communications terminals or communications installations. The connection between the primary control unit and the communications installation or the communications terminal can be the data network or else a serial or other connection, which operate on the basis of a proprietary transmission standard, in particular. The control data which can be transmitted using this standard are normally more comprehensive than the control data defined in the H.323 standard.

In the case of the known terminal systems including the associated transmission methods, it has been found to be disadvantageous that, for a communications link which operates on the basis of a known transmission standard, which is widely used and has already been found to be adequate, like the H.323 standard, control data can be interchanged only to a restricted extent under today's circumstances, whereas proprietary transmission standards for modern CTI communications applications offer a much wider scope.

It is an object to extend data interchange between a telecommunications installation and a media application (communications application) using a widely used and tried-and-tested, and hence secure, transmission standard between the telecommunications installation and a primary control unit (control means TAPI driver) and using a standardized programming interface between the primary control unit and the media application.

### SUMMARY OF THE INVENTION

The solution for the apparatus and for the method provides that a second transmission path based on a second transmission standard is provided for interchanging extended control data between an auxiliary control unit and the communications installation, that the basic control data, upon transmission from the communications installation to the communications application, are first transferred from the primary control unit to the auxiliary control unit, are combined with the extended control data by the auxiliary control unit, and are then transmitted as combined control data from the auxiliary control unit to the primary control unit for forwarding to the communications application, and, conversely, the control data to be transmitted from the communications application to the communications installation are passed to the primary control unit, are forwarded to the auxiliary control unit by the primary control unit using the second control data channel, are split into basic control data and extended control data by the auxiliary control unit, and the basic control data are transmitted to the first control data channel for forwarding to the communications installation via the first transmission path, while the extended control data are forwarded via the second transmission path. In this context, communications links via data networks can be operated using a generally used standard, and this also involves using such control data and control commands as go beyond those known in this standard. The communications application, the primary control unit and the standard for transmitting the basic control data and the user data remain unchanged in this instance.

By virtue of the primary control unit being in the form of a TAPI driver from version 3.0 onward, both control data and user data can be interchanged with the communications application via a TAPI interface, in which case easy-to-install TAPI-based communications applications can be used.

The use of an Internet Protocol network (IP network) for transmitting all the data is advantageous because such networks operating on the basis of the Internet Protocol are widely used and have already been tried and tested.

When operating VolP systems (Voice-over-IP=voice transmission using the Internet Protocol), a tried-and-tested and generally recognized transmission standard is used in most cases. The functionality which can be achieved using this standard alone for controlling the communications link is significantly extended with little complexity using the method.

The International Telecommunication Union standard (ITU-H.323 standard) is widely used and is implemented in a large number of communications installations and communications appliances, which means that its use in the apparatus allows communication with virtually all communications appliances which use this standard. The H.323 standard is also suitable for transmitting user data in various data formats.

For the purpose of simple installation and handling, it is advantageous for the communications application together with the primary control unit and the auxiliary control unit to be arranged together in one appliance.

The further use of a communications application based on the known interface of the primary control unit is simplified if the combined control data are managed by a second control data channel of the primary control unit.

The use of existing communications installations and existing networks is associated with little complexity if the second transmission standard used is a protocol for networking communications installations which already exists in said existing communications installations, and the auxiliary control unit behaves toward the connected communications installation(s) as a further communications installation, networked using this standard.

### BRIEF DESCRIPTION OF THE DRAWINGS

These and other objects and advantages of the present invention will become more apparent and more readily appreciated from the following description of the preferred embodiments, taken in conjunction with the accompanying drawings of which:

The single FIGURE shows a schematic illustration of the apparatus for data interchange.

### DETAILED DESCRIPTION OF THE PREFERRED EMBODIMENT

Reference will now be made in detail to the preferred embodiments of the present invention, examples of which are illustrated in the accompanying drawings, wherein like reference numerals refer to like elements throughout.

The data interchange involves user data, for example audio and video data, and control data being interchanged between a communications installation 1 having an associated network interface 1a and a media application 2. The media application 2 runs on a computer (PC), which is not shown. In this case, the user data and control data are transmitted in both directions, from the communications installation 1 to the media application 2 and vice versa, which is illustrated in the figure by the double-headed arrows.

The text below first describes data transmission from the communications installation 1 in the direction of the media application 2:

The user data and control data are transmitted (to the PC) from the network interface 1a via an LAN data network 1b. Transmission is effected on the basis of a known transmission standard, the H.323 standard. A connection 3 based on the H.323 standard comprises two logical channels, a control data channel 3a for basic control data and a user data channel 3b. The data transmitted via the connection 3 are processed further on the PC by a TAPI driver 4a as primary control unit 4, the TAPI driver 4a (version 3.0 or above) being able to handle not only the control data but also the user data. The TAPI driver 4a can manage at least two control data channels 3a, 5c from different connections (3 and connection based on protocol 5b) and can interchange these control data channels 3a, 5c with various devices, that is to say the media application 2 and a further driver 5a, for example, via the TAPI interface 4c.

The user data transmitted from the user data channel 3b to the TAPI driver 4a are forwarded directly to the media application 2 by the TAPI driver 4a using a user data channel 4b of the standardized interface 4c of the TAPI driver 4a.

In a similar manner to the connection based on the H.323 standard, the TAPI interface 4c also has various logical channels available, namely user data channels and control data channels 4b, 4d.

The basic control data transmitted in the control data channel 3a for the connection 3 are transmitted by the TAPI driver 4a via a control data channel of the TAPI interface 4c to an additional driver as auxiliary control unit 5, the MEB driver 5a (MEB=Media Extension Bridge).

For interchanging additional control data, the extended control data, which cannot be produced in the control data channel 3a for the connection 3, the communications installation 1 has a further network interface 1c, which likewise transmits the extended control data via the LAN data network 1b to the MEB driver 5a. The network interface 1c is a proprietary interface (networking interface) provided in the communications installation 1. The connection 5b between the interface 1c and the MEB driver 5a proceeds in accordance with the associated proprietary transmission standard.

Thus, the basic control data transmitted by the control data channel 3a via the TAPI driver 4a and the extended control data transmitted via the connection 5b convene in the MEB driver 5a. The MEB driver 5a then makes the basic control data and the extended control data jointly available to the TAPI driver 4a again via an additional control data channel 5c. The TAPI driver 4a assigns the combined control data to the user data channel and transmits them, correlated to the user data, to the media application 2 via the TAPI interface 4c.

The text below describes the data transmission in the opposite direction:

In the flow of data from the media application 2 to the communications installation 1, the user data from the media application 2 are first transmitted via the user data channel 4b of the TAPI interface 4c to the TAPI driver 4a, and are then transmitted from the latter to the network interface 1a of the communications installation 1 via the user data channel 3b for the connection 3 over the LAN data network 1b. The “combined” control data to be transmitted from the media application 2 to the communications installation 1 are transmitted from the media application 2 to the TAPI driver 4a via the control data channel of the TAPI interface 4d. The TAPI driver 4a sends these control data to the MEB driver 5a via the connection 5c. The MEB driver 5a splits these “combined” control data into basic control data and extended control data. The basic control data are transmitted from the MEB driver 5a via the control data channel of the TAPI interface 4c to the TAPI driver 4a, and from there via the control data channel 3a for the connection 3 over the LAN data network 1b to the network interface 1a of the communications installation 1. The extended control data are transferred from the MEB driver 5a to the interface 1c of the communications installation 1 via the connection 5b in the LAN data network 1b.

It is thus possible to use the media application 2, which is based on a TAPI driver 4a and communicates via a tried-and-tested H.323 connection 3, to use extended functions which are not defined in the H.323 standard. The application itself is not changed for this purpose.

Following setup of the MEB driver 5a, the TAPI driver 4a has at least two control data channels 3a, 5c (TSP=TAPI Service Provider) available, one from the H.323 connection accessed by the MEB driver 5a and another from the MEB driver 5a accessed by the media application 2.

The invention has been described in detail with particular reference to preferred embodiments thereof and examples, but it will be understood that variations and modifications can be effected within the spirit and scope of the invention.

What is claimed is:

1. An apparatus for interchange of user data and control data associated with the user data between a communications application and a communications installation which are connected via a packet-switched network, comprising:
an application-end primary control unit, which interchanges combined control data with the communications application, the primary control unit having first and second channels;
a first transmission path to interchange basic control data and the user data, on the basis of a first transmission standard, between the primary control unit and the communications installation, the basic control data being transmitted using the first channel;
a second transmission path based on a second transmission standard, to transmit extended control data to and from the communications installation;
an auxiliary control unit to interchange extended control data with the communications installation via the second transmission path, to interchange basic control data with the first channel of the primary control unit, and to interchange combined control data with the second channel of the primary control unit; and
a splitting-combining element provided in the auxiliary control unit to split combined control data into basic control data and extended control data and to form combined control data by combining basic control data and extended control data.

2. The apparatus as claimed in claim 1, wherein the primary control unit is a TAPI driver from version 3.0 onward, and the communications application is a piece of TAPI-compliant software.

3. The apparatus as claimed in claim 1, wherein the packet-switched network is an IP network.

4. The apparatus as claimed in claim 1, wherein the communications installation is part of a Voice-over-IP system.

5. The apparatus as claimed in claim 1, wherein the first transmission path is a communications link based on ITU-H.323 standard.

6. The apparatus as claimed in claim 1, wherein the primary control unit, the auxiliary control unit and the communications application are installed on a common personal computer.

7. The apparatus as claimed in claim 1, wherein
the second transmission standard is a protocol for networking communications installations, and
in the interchange of the extended control data, the auxiliary control unit behaves as a networked communications installation toward the communications installation.

8. The apparatus as claimed in claim 2, wherein the packet-switched network is an IP network.

9. The apparatus as claimed in claim 8, wherein the communications installation is part of a Voice-over-IP system.

10. The apparatus as claimed in claim 9, wherein the first transmission path is a communications link based on ITU-H.323 standard.

11. The apparatus as claimed in claim 10, wherein the primary control unit, the auxiliary control unit and the communications application are installed on a common personal computer.

12. The apparatus as claimed in claim 11, wherein
the second transmission standard is a protocol for networking communications installations, and
in the interchange of the extended control data, the auxiliary control unit behaves as a networked communications installation toward the communications installation.

13. A method for interchanging user data and control data associated with the user data between a communications application and a communications installation which are connected via a packet-switched network, comprising:
interchanging basic control data and the user data on the basis of a first transmission standard between a primary control unit and the communications installation, the basic control data and the user data being interchanged via a first transmission path;
interchanging extended control data between an auxiliary control unit and the communications installation, the extended control data being interchanged via a second transmission path and a second communications standard;
upon transmission from the communications installation to the communications application:
passing the basic control data from the communications installation to the primary control unit via the first transmission path,
transferring the basic control data from the primary control unit to the auxiliary control unit,
combining the basic control data with the extended control data in the auxiliary control unit to thus form combined control data,
transferring the combined control data from the auxiliary control unit to the second control data channel of the primary control unit, and
forwarding the combined control data from the primary control unit to the communications application; and
upon transmission from the communications application to the communications installation:
passing combined control data from the communications application to the primary control unit,
forwarding the combined control data from the primary control unit to the auxiliary control unit using the second control data channel of the primary control unit,
splitting the combined control data into basic control data and extended control data in the auxiliary control unit,
transmitting the basic control data to the first control data channel of the primary control unit,
forwarding the basic control data to the communications installation via the first transmission path, and
forwarding the extended control data via the second transmission path.
